(19) United States
(12) Patent Application Publication
(10) Pub. No.: US 2022/0405907 A1
(43) Pub. Date: Dec. 22, 2022

(54) INTEGRATED SYSTEM FOR DETECTING AND CORRECTING CONTENT

(71) Applicant: Microsoft Technology Licensing, LLC, Redmond, WA (US)

(72) Inventors: Fatima Zohra DAHA, Santa Clara, CA (US); Amit SRIVASTAVA, San Jose, CA (US); Nicolas Paul-Stringall HIGUERA, Davis, CA (US); Robert Fernand GORDAN, Menlo Park, CA (US)

(21) Appl. No.: 17/352,320

(22) Filed: Jun. 20, 2021

(51) Int. Cl. G06T 7/00; G06T 7/194; G06K 9/62; G06T 5/00; G06K 9/00; G06T 7/11; H04N 7/15

(52) U.S. Cl. CPC G06T 7/0002; G06T 7/194; G06K 9/6267; G06T 5/002; G06K 9/00335; G06T 7/11; H04N 7/15; G06T 2207/10016; G06T 2207/20081; G06T 2207/20076; G06T 2207/30196

(57) ABSTRACT

Aspects of the present disclosure relate to systems and methods for detecting and correcting undesirable content. A video feed may be segmented to distinguish background data from foreground data. It may be determined that a region of the background data includes a qualifying behavior. The qualifying behavior may be classified as belonging to a distracting category of data. An effect may be applied to the background data that includes the qualifying behavior to reduce an appearance of the qualifying behavior.

### BACKGROUND

Video feed technology is becoming increasingly popular for communicating and conducting conferences, meetings, conversations, and the like. In this regard, users and their associated backgrounds are generally visible to others during the communication, meeting, etc. In one example, users may have some type of distraction in the background without them noticing. In another example, a user may make an undesirable gesture without realizing it. As such, these actions may create discomfort for other users and/or disrupt the video communication. Currently, a user is required to manually turn off their video feed or apply a background effect such as choosing an image as their background. Both techniques may result in disruption of the video communication, meeting, etc. In turn, current techniques for reducing undesirable effects during video communications are inefficient and inadequate.

### OVERVIEW

This Overview is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for detecting and correcting undesirable content. A method for correcting distracting data is presented. The method may include segmenting video feed to distinguish background data from foreground data. The method may further include determining that a region of the background data includes a qualifying behavior. The method may further include classifying the qualifying behavior as belonging to a distracting category of data. The method may further include applying an effect to the region of the background data that includes the qualifying behavior to reduce an appearance of the qualifying behavior.

In another aspect, a method for classifying a distracting category of data for correction is presented. The method may include detecting that one or more regions of background data include at least one qualifying behavior. The method may further include obtaining a probability score associated with the at least one qualifying behavior. The method may further include when the probability score is above a distraction threshold value, applying an effect to the background data to reduce an appearance of the one or more regions of the background data that include the at least one qualifying behavior.

In further aspects, data may be segmented to distinguish background data from foreground data. A motion may be detected in a region of the background data. The motion may be classified as a distracting motion. An effect may be applied to the background data to reduce an appearance of the detected motion.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary integrated system implemented at a client computing device for detecting and correcting content, according to an example aspect.

FIG. 2 illustrates an exemplary integrated system implemented at a server computing device for detecting and correcting content, according to an example aspect.

FIG. 3A illustrates one view in a progression of views of a video communication application, according to an example aspect.

FIG. 3B illustrates another view in the progression of views of the video communication application of FIG. 3A, according to an example aspect.

FIG. 4 illustrates an exemplary method for correcting distracting content, according to an example aspect.

FIG. 5 illustrates an exemplary method for classifying a distracting category of data for correction, according to an example aspect.

FIG. 6 illustrates a computing system suitable for implementing the enhanced content detection and correction technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to detecting and correcting undesirable content. For example, data may be segmented to distinguish background data from foreground data. In one example, the data may include a video feed such as the video feed utilized during a video meeting, conference call, conversation, and the like. The data may be segmented as successive frames of data (e.g., video clips/frames) are received at a segmentation component. The segmentation component may include one or more segmentation models for distinguishing background data from foreground data, one or more regions of the background data, and the like. It may be determined that a region of the background data includes a qualifying behavior. For example, the qualifying behavior may include at least one of a motion and an object. In this regard, it may be determined that a region of the background data includes motion, for example. The qualifying behavior may be classified as belonging to a distracting category of data. For example, when the qualifying behavior is motion, the motion may be classified as being distracting motion and belonging to a distracting category of data. In one example, a classification model may be applied to the background data to obtain a probability score. The probability score may indicate the probability of the qualifying behavior belonging to the distracting category of data (e.g., the probability that the qualifying behavior is distracting). An effect may be applied to the region of the background data that includes the qualifying behavior to reduce an appearance of the qualifying behavior. In one example, the effect may include blurring the background data. In another example, the effect may include blurring the region of the background data that includes the qualifying behavior. In this regard, the distracting behavior may be invisible to other users preventing distraction and/or disruption of the video communication. In other examples, an unintentional gesture may be detected in the foreground data. A deep learning component may be applied to one or more successive frames of data (e.g., video clips/frames) to detect the unintentional gesture. In response to detecting the unintentional gesture in the foreground data, the video feed may be automatically turned off such that other users don't see the unintentional gesture.

As discussed above, users may have some type of distraction in the background of a video communication without them noticing. In another example, a user may make an undesirable gesture without realizing it. As such, these actions may create discomfort for other users and/or disrupt the video communication. Currently, a user is required to manually turn off their video feed or apply a background effect such as choosing an image as their background. Both techniques may result in disruption of the video communication, meeting, etc. In turn, current techniques for reducing undesirable effects during video communications are inefficient and inadequate. Accordingly, aspects described herein include detecting and correcting undesirable content to avoid distraction and disruption during video communication. In one aspect, a distracting category of data for correction may be classified. At least one qualifying behavior may be detected in one or more regions of background data. In another example, at least one unintended and/or undesirable gesture may be detected in foreground data. A probability score associated with the at least one qualifying behavior may be obtained. In one example, the probability score may be obtained by supplying the background data to a classification component. The classification component may include one or more classification models that include at least one of traditional computer visioning techniques and deep learning models. In this regard, the classification component may include at least a distraction profile. The distraction profile may include distraction characteristics that indicate the qualifying behavior belongs to a distracting category of data. The background data including the at least one qualifying behavior may be compared to the distraction profile. For example, it may be determined that the characteristics of the detected qualifying behavior match 60% of the distraction characteristics included in the distraction profile. In this example, the probability score may be 0.6.

In some examples, when the probability score is above a distraction threshold value, an effect may be applied to the background data to reduce an appearance of the one or more regions of the background data that include the at least one qualifying behavior. The distraction threshold value may be configured to improve the quality of the detection and correction of distracting content. In some cases, a bounding box may be applied to the one or more regions including the at least one qualifying behavior. In this regard, an additional effect may be applied to the bounding box to further reduce the appearance of the one or more regions of the background data that include the at least one qualifying behavior. In this regard, a technical effect that may be appreciated is that by classifying a distracting category of data during video communications, undesirable, distracting, and inappropriate content detection and correction technology is improved. Another technical effect that may be appreciated is that via the enhanced content detection and correction technology described herein, distracting and/or inappropriate content (e.g., behaviors, objects, gestures, and the like) is detected and corrected (e.g., by applying an effect to reduce the appearance of the distracting content and/or making the inappropriate content invisible) that would otherwise disrupt important video communications and/or be prone to human error (e.g., users not noticing they have a distraction in the background that is disrupting a meeting, for example).

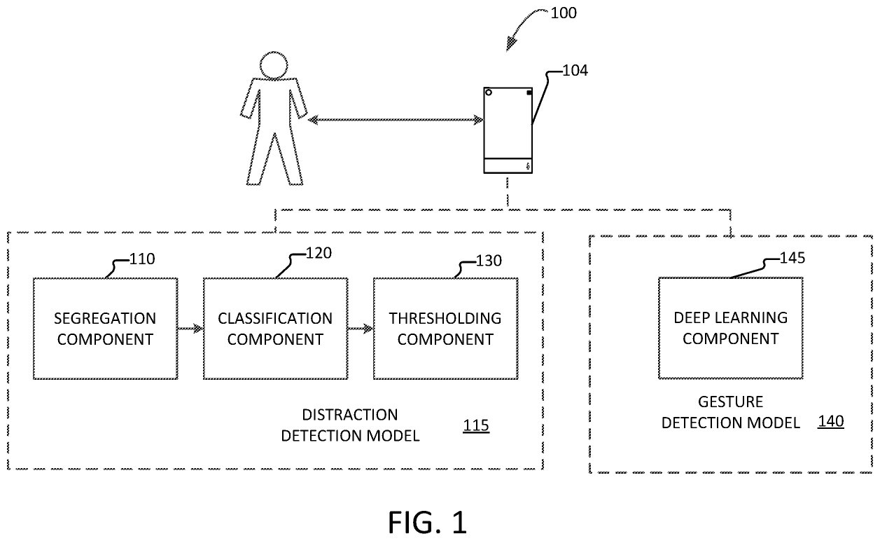

Referring now to the drawings, in which like numerals represent like elements through the several figures, aspects of the present disclosure and the exemplary operating environment will be described. With reference to FIG. 1, one aspect of an integrated system 100 for content detection and correction is illustrated. In one example, the integrated system 100 may be a machine-learning enabled integrated system. In aspects, the integrated system 100 may be implemented on a client computing device 104. In a basic configuration, the client computing device 104 is a handheld computer having both input elements and output elements. The client computing device 104 may be any suitable computing device for implementing the integrated system 100 for content detection and correction. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for the integrated system 100 for content detection and correction may be utilized.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As illustrated in FIG. 1, the client computing device 104 may include distraction detection model 115 and a gesture detection model 140. The distraction detection model 115 may include a segregation component 110, a classification component 120, and a thresholding component 130. The gesture detection model 140 may include a deep learning component 145. The various components may be implemented using hardware, software, or a combination of hardware and software. In examples, a user interface component of the client computing device 104 may initiate rendering of video communication application in a user interface of the client computing device 104 (not illustrated). In some examples, the video communication application may include an application and/or platform such as Teams.

In one example, the distraction detection model 115 may be configured to detect and correct distracting content and/or data. The content and/or data may be produced in an online video feed during a video communication. For example, the video communication may include a video call, conference, meeting, and the like using a video application and/or video platform. In one example, the video application and/or video platform may include video platforms such as Teams, Zoom, Slack, and the like. It is appreciated that any video communication technology, application, and/or platform may be used to produce content and/or data for use in conjunction with the present disclosure. The distraction detection model 115 may include any combination of machine learning based techniques and rules and/or computer vision techniques. In some cases, the machine learning based techniques may include techniques such as artificial neural networks, convolutional neutral networks, Bayesian classifiers, and/or genetically derived algorithms and/or functions.

In another example, the distraction detection model 115 may be trained using training data. For example, a plurality of samples of data including distracting content may be used to train the distraction detection model 115 to detect and correct distracting content. In one example, the distraction detection model 115 may be trained to classify data as belonging to a distracting category of data. In this regard, while an online video feed is live, the distraction detection model 115 may receive one or more successive frames of data. For example, the one or more successive frames of data may include one or more shot segments of the live online video feed. As such, the segmentation component 110 of the distraction detection model 115 may be configured to receive one or more successive frames of data (e.g., an online video feed). In one example, the one or more successive frames of data received at the segmentation component 110 may include four successive frames of data. In another example, the one or more successive frames of data received at the segmentation component 110 may include eight successive frames of data. In yet another example, the segmentation component 110 may be configured to receive any number of successive frames of data (e.g., video clips).

The segmentation component 110 may be configured to segment data (e.g., a video feed) to distinguish background data from foreground data. The segmentation component 110 may include one or more segmentations models. For example, one segmentation model may be configured to distinguish background data from foreground data. The background data distinguished from the foreground data may be from an online video feed (e.g., during a videoconferencing call/meeting). In this example, the foreground data may include a face and/or body of a person participating in the videoconferencing call/meeting. The background data may include the area behind and surrounding the person participating in the videoconferencing call, i.e., the background of the video feed. In this regard, the background data may include one or more regions including objects, sounds, people, pets, nature, and the like.

In other examples, another segmentation model may be configured to distinguish the one or more regions of the background data. For example, one segmentation model may be configured to segment one region of the background data from other regions of the background data. Another segmentation models may be configured to segment another region of the background data from the other regions of the background data. As discussed above, the one or more regions of the background data may include objects, sounds, people, pets, nature, and the like. In this regard, one segmentation model may be configured to segment a region including a person, for example, from the rest of the background data. In another example, the segmentation model may be configured to segment the region including the person from other regions including other objects of the background data. As such, as discussed herein, the segmentation component 110 may be configured to distinguish and/or segment data to identify one or more regions of the data (e.g., background data from foreground data, one object from another object, and the like).

When one or more regions of data are segmented, it may be determined that at least one of the regions of data includes a qualifying behavior. In this regard, the classification component 120 may be configured to determine that a region of the data includes a qualifying behavior. In one example, the region of data determined to include the qualifying behavior may be a region of the background data. The qualifying behavior may include any behavior that can be classified as distracting, cause disruption to a meeting (e.g., during a video communication), and/or cause participants to feel uncomfortable. For example, the qualifying behavior may include at least one of a motion and an object. The motion may include any type of motion detected in the background data, as discussed herein. For example, the motion may include a person, a pet, a plant, nature, or any object that is in motion. The object may include any object in the background data such as a plant, a TV, furniture, a picture, a pet, and the like.

In some examples, the classification component 120 includes one or more classification models that include at least one of traditional computer visioning techniques and deep learning models. In this regard, determining that a region of the data includes a qualifying behavior may include applying a classification model such as a motion detection model to the data (e.g., the background data). For example, the motion detection model may process and analyze successive frames of background data to detect a difference in pixels from one frame to the next. This may indicate that at least a region of the background data includes a qualifying behavior.

In other examples, the classification component 120 may be configured to detect that more than one region of the background data includes at least one qualifying behavior. For example, the classification component 120 may detect that two regions of the background data include at least one qualifying behavior. For example, one region may include a motion and the other region may include an object such as a TV. As discussed above, the segmentation component 110 may be configured to distinguish background data from foreground data and distinguish one or more regions of the background data. In this regard, when the background data is segmented into multiple regions, the classification component 120 may be configured to determine whether each region of the multiple regions of background data includes a qualifying behavior.

When it is determined that the background data and/or a region of the background data includes a qualifying behavior, the qualifying behavior may be classified as belonging to a distracting category of data. In this regard, the classification component 120 may be configured to classify the qualifying behavior as belonging to a distracting category of data. As discussed above, the classification component may include one or more classification models that include at least one of traditional computer visioning techniques and deep learning models. The distracting category of data may include qualifying behaviors that are characterized as distracting. For example, the classification component 120 may classify motion as a distracting motion. In this example, the classification component 120 may detect a motion in a region of the background data and classify it as a distracting motion.

In one example, classifying the qualifying behavior as belonging to a distracting category of data includes applying a classification model to the background data to obtain a probability score. The probability score may be associated with the qualifying behavior. For example, the probability score may indicate the probability of the qualifying behavior belonging to the distracting category of data. For example, when the qualifying behavior is a motion detected in the background data, the probability score of the motion indicates the probability that the motion is a distracting motion. Obtaining a probability score may include supplying the background data to the classification component 120 (e.g., supplying the background data to one or more classification models). When the background data is supplied to the classification component 120, the classification component 120 may compare the background data including at least one qualifying behavior to a distraction profile. The distraction profile may include distraction characteristics that indicate the qualifying behavior belongs to the distracting category of data. For example, the distraction profile may indicate that XYZ characteristics of a qualifying behavior are distracting and belong to the distracting category of data. In this regard, when the detected qualifying behavior is compared to the distraction profile, a match percentage between the characteristics of the detected qualifying behavior and the distraction characteristics included in the distraction profile may be determined. For example, the characteristics of the detected qualifying behavior may match 80% of the distraction characteristics included in the distraction profile. In this example, the probability score may be 0.8.

In some examples, the thresholding component 130 may be configured to set a distraction threshold value. The distraction threshold value may be configured to determine whether a probability score belongs to the distracting category of data. For example, the distraction threshold value may be set to 0.5. This may indicate that a qualifying behavior with a probability score above 0.5 belongs to the distracting category of data. The distraction threshold value may be configured for each segmented region of background data and/or for each detected qualifying behavior. In other words, the distraction threshold value may be set to a different value for each detected qualifying behavior. For example, when the qualifying behavior is a motion in the background data, it may be determined that a probability score above 0.5 indicates the motion is distracting (e.g., belongs to the distracting category of data). In this example, the distraction threshold value may be set to 0.5. In another example, when the qualifying behavior is an object such as a TV in the background data, it may be determined that a probability score above 0.9 indicates the TV is distracting. In this example, the distraction threshold value may be set to 0.9.

When the qualifying behavior is classified as belonging to a distracting category of data (e.g., when it is classified as a distracting behavior), the classification component 120 and/or the thresholding component 130 may be configured to apply an effect to the region of the background data that includes the qualifying behavior to reduce an appearance of the qualifying behavior. In this regard, an effect may be applied to the region of the background data that includes the qualifying behavior to reduce an appearance of the qualifying behavior when the probability score is above the distraction threshold value. In some examples, an effect may be applied to the background data to reduce an appearance of one or more regions of the background data that include the at least one qualifying behavior. In one example, when the affect is applied to the region of the background data that includes the qualifying behavior, the effect may include blurring the region of the background data that includes the qualifying behavior. In another example, when the effect is applied to the background data, the effect may include blurring the background data to reduce an appearance of the qualifying behavior. In one example, the background data may be blurred to reduce an appearance of the distracting motion. As such, an effect, such as blurring, may be applied to the background data to reduce an appearance of at least one qualifying behavior and an effect, such as blurring, may be applied to one or more regions of the background data to reduce an appearance of the at least one qualifying behavior. It is appreciated that any effect may be applied in accordance with the present disclosure that can reduce an appearance of a qualifying behavior.

In one example, when a qualifying behavior is detected in one or more regions of the background data, a bounding box may be applied to the one or more regions including the at least on qualifying behavior. In this regard, an additional effect may be applied to the bounding box to further reduce the appearance of the one or more regions of the background data that include the at least one qualifying behavior. As such, a first effect may be applied to the background data and a second effect may be applied to one or more regions of the background data. In some examples, the bounding box facilitates the application of the effect to a finer region of the qualifying behavior.

In one example, a distraction profile may be created for each region of the background data defined by the segmentation component 110. In another example, a distraction profile may be created for each qualifying behavior detected via the classification component 120. For example, a distraction profile may be created for a first type of motion (e.g., a pet moving in the background). In another example, a distraction profile may be created for a second type of motion (e.g., a person moving around in the background). In yet another example, a distraction profile may be created for an object in the background such as a TV. In this regard, when each of these qualifying behaviors is detected in the background data, the classification component 120 may apply one or more classification models associated with each qualifying behavior. The one or more classification models may have a distraction profile associated with each qualifying behavior.

In aspects, as discussed above, the integrated system 100 may include the gesture detection model 140. The gesture detection model 140 may be configured to detect and correct inappropriate and/or unintended content and/or gestures. The content and/or data may be produced in an online video feed during a video communication. For example, the video communication may include a video call, conference, meeting, and the like using a video application and/or video platform. In one example, the video application and/or video platform may include video platforms such as Teams, Zoom, Slack, and the like. It is appreciated that any video communication technology, application, and/or platform may be used to produce content and/or data for use in conjunction with the present disclosure. The gesture detection model 140 may include any combination of machine learning based techniques and rules. In some cases, the machine learning based techniques may include techniques such as artificial neural networks, convolutional neutral networks, Bayesian classifiers, and/or genetically derived algorithms and/or functions.

In another example, the gesture detection model 140 may be trained using training data. For example, a plurality of samples of data including defined inappropriate and/or unintended gestures may be used to train the gesture detection model 140 to detect and correct inappropriate content. The defined inappropriate and/or unintended gestures may include gestures such as yawning, coughing, nose picking, and the like. As discussed above, the gesture detection model 140 may include the deep learning component 145. The deep learning component 145 may be configured to detect an unintentional gesture in the foreground data. For example, the deep learning component 145 may apply one or more (e.g., a combination) of machine learning based techniques/deep learning models to the one or more successive frames of the foreground data to detect an unintentional gesture. In some examples, the deep learning component 145 may determine that the foreground data includes a match to one of the defined inappropriate gestures that have been characterized by the deep learning component 145. In response to detecting the unintentional gesture in the foreground data, the deep learning component 145 may automatically turn off the video feed. In this regard, other participants in a video communication will not be exposed to the inappropriate gesture. Thus, avoiding disruption of the video communication.

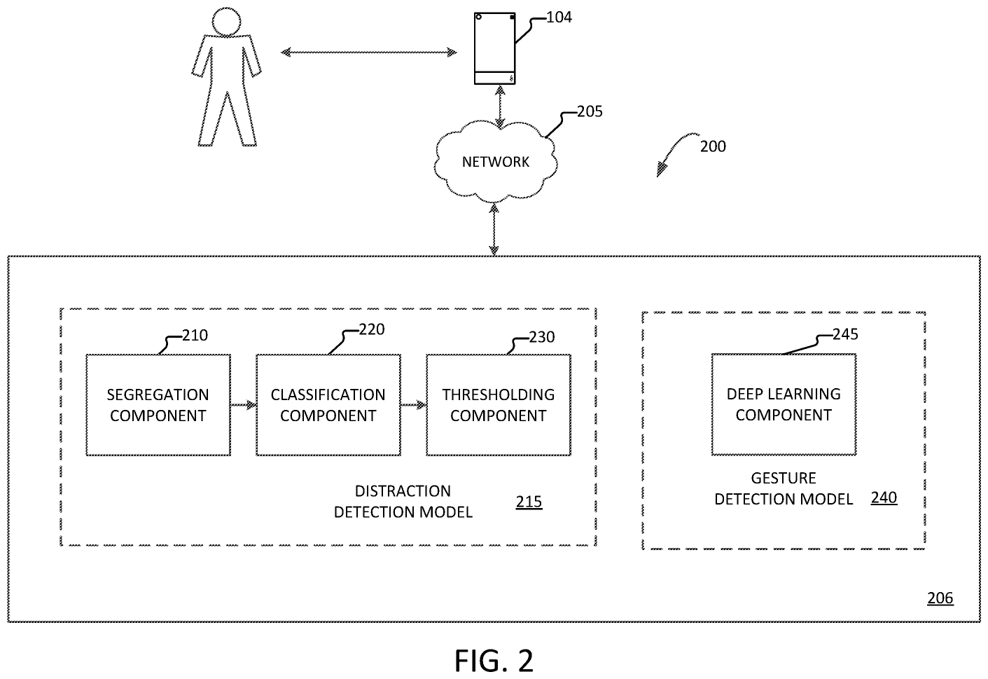

FIG. 2 illustrates one aspect of an integrated system 200 for correcting and detecting data/content. In aspects, the integrated system 200 may be implemented on a server computing device 206. The server computing device 206 may provide data to and from the client computing device 104 through a network 205. In aspects, the integrated system 200 may be implemented on more than one server computing device 206, such as a plurality of server computing devices 206. In one example, the server computing device 206 includes a cloud service. In another example, the server computing device 206 includes an application service. The data may be communicated over any network suitable to transmit data. In some aspects, the network 205 is a distributed computer network such as the Internet. In this regard, the network 205 may include a Local Area Network (LAN), a Wide Area Network (WAN), the Internet, wireless and wired transmission mediums. In some aspects, the integrated system 200 may be implemented on both a client computing device 104 and a server computing device 206.

As illustrated in FIG. 2, the server computing device 206 may include distraction detection model 215 and a gesture detection model 240. The distraction detection model 215 may include a segregation component 210, a classification component 220, and a thresholding component 230. The gesture detection model 240 may include a deep learning component 245. The various components may be implemented using hardware, software, or a combination of hardware and software. In examples, a user interface component of the client computing device 104 may initiate rendering of video communication application in a user interface of the client computing device 104 (not illustrated). In some examples, the video communication application may include an application and/or platform such as Teams.

In one example, the distraction detection model 215 may be configured to detect and correct distracting content and/or data. The content and/or data may be produced in an online video feed during a video communication. For example, the video communication may include a video call, conference, meeting, and the like using a video application and/or video platform. In one example, the video application and/or video platform may include video platforms such as Teams, Zoom, Slack, and the like. It is appreciated that any video communication technology, application, and/or platform may be used to produce content and/or data for use in conjunction with the present disclosure. The distraction detection model 215 may include any combination of machine learning based techniques and rules and/or computer vision techniques. In some cases, the machine learning based techniques may include techniques such as artificial neural networks, convolutional neutral networks, Bayesian classifiers, and/or genetically derived algorithms and/or functions.

In another example, the distraction detection model 215 may be trained using training data. For example, a plurality of samples of data including distracting content may be used to train the distraction detection model 215 to detect and correct distracting content. In one example, the distraction detection model 215 may be trained to classify data as belonging to a distracting category of data. In this regard, while an online video feed is live, the distraction detection model 215 may receive one or more successive frames of data. For example, the one or more successive frames of data may include one or more shot segments of the live online video feed. As such, the segmentation component 210 of the distraction detection model 215 may be configured to receive one or more successive frames of data (e.g., an online video feed). In one example, the one or more successive frames of data received at the segmentation component 210 may include four successive frames of data. In another example, the one or more successive frames of data received at the segmentation component 210 may include eight successive frames of data. In yet another example, the segmentation component 210 may be configured to receive any number of successive frames of data (e.g., video clips).

The segmentation component 210 may be configured to segment data (e.g., a video feed) to distinguish background data from foreground data. The segmentation component 210 may include one or more segmentations models. For example, one segmentation model may be configured to distinguish background data from foreground data. The background data distinguished from the foreground data may be from an online video feed (e.g., during a videoconferencing call/meeting). In this example, the foreground data may include a face and/or body of a person participating in the videoconferencing call/meeting. The background data may include the area behind and surrounding the person participating in the videoconferencing call, i.e., the background of the video feed. In this regard, the background data may include one or more regions including objects, sounds, people, pets, nature, and the like.

In other examples, another segmentation model may be configured to distinguish the one or more regions of the background data. For example, one segmentation model may be configured to segment one region of the background data from other regions of the background data. Another segmentation models may be configured to segment another region of the background data from the other regions of the background data. As discussed above, the one or more regions of the background data may include objects, sounds, people, pets, nature, and the like. In this regard, one segmentation model may be configured to segment a region including a person, for example, from the rest of the background data. In another example, the segmentation model may be configured to segment the region including the person from other regions including other objects of the background data. As such, as discussed herein, the segmentation component 210 may be configured to distinguish and/or segment data to identify one or more regions of the data (e.g., background data from foreground data, one object from another object, and the like).

When one or more regions of data are segmented, it may be determined that at least one of the regions of data includes a qualifying behavior. In this regard, the classification component 220 may be configured to determine that a region of the data includes a qualifying behavior. In one example, the region of data determined to include the qualifying behavior may be a region of the background data. The qualifying behavior may include any behavior that can be classified as distracting, cause disruption to a meeting (e.g., during a video communication), and/or cause participants to feel uncomfortable. For example, the qualifying behavior may include at least one of a motion and an object. The motion may include any type of motion detected in the background data, as discussed herein. For example, the motion may include a person, a pet, a plant, nature, or any object that is in motion. The object may include any object in the background data such as a plant, a TV, furniture, a picture, a pet, and the like.

In some examples, the classification component 220 includes one or more classification models that include at least one of traditional computer visioning techniques and deep learning models. In this regard, determining that a region of the data includes a qualifying behavior may include applying a classification model such as a motion detection model to the data (e.g., the background data). For example, the motion detection model may process and analyze successive frames of background data to detect a difference in pixels from one frame to the next. This may indicate that at least a region of the background data includes a qualifying behavior.

In other examples, the classification component 220 may be configured to detect that more than one region of the background data includes at least one qualifying behavior. For example, the classification component 220 may detect that multiple regions of the background data include at least one qualifying behavior. For example, one region may include a motion and the other region may include an object such as a plant. As discussed above, the segmentation component 210 may be configured to distinguish background data from foreground data and distinguish one or more regions of the background data. In this regard, when the background data is segmented into multiple regions, the classification component 220 may be configured to determine whether each region of the multiple regions of background data includes a qualifying behavior.

When it is determined that the background data and/or a region of the background data includes a qualifying behavior, the qualifying behavior may be classified as belonging to a distracting category of data. In this regard, the classification component 220 may be configured to classify the qualifying behavior as belonging to a distracting category of data. As discussed above, the classification component may include one or more classification models that include at least one of traditional computer visioning techniques and deep learning models. The distracting category of data may include qualifying behaviors that are characterized as distracting. For example, the classification component 220 may classify motion as a distracting motion. In this example, the classification component 220 may detect a motion in a region of the background data and classify it as a distracting motion.

In one example, classifying the qualifying behavior as belonging to a distracting category of data includes applying a classification model to the background data to obtain a probability score. The probability score may be associated with the qualifying behavior. For example, the probability score may indicate the probability of the qualifying behavior belonging to the distracting category of data. For example, when the qualifying behavior is a motion detected in the background data, the probability score of the motion indicates the probability that the motion is a distracting motion. Obtaining a probability score may include supplying the background data to the classification component 220 (e.g., supplying the background data to one or more classification models). When the background data is supplied to the classification component 220, the classification component 220 may compare the background data including at least one qualifying behavior to a distraction profile. The distraction profile may include distraction characteristics that indicate the qualifying behavior belongs to the distracting category of data. For example, the distraction profile may indicate that XYZ characteristics of a qualifying behavior are distracting and belong to the distracting category of data. In this regard, when the detected qualifying behavior is compared to the distraction profile, a match percentage between the characteristics of the detected qualifying behavior and the distraction characteristics included in the distraction profile may be determined. For example, the characteristics of the detected qualifying behavior may match 90% of the distraction characteristics included in the distraction profile. In this example, the probability score may be 0.9.

In some examples, the thresholding component 230 may be configured to set a distraction threshold value. The distraction threshold value may be configured to determine whether a probability score belongs to the distracting category of data. For example, the distraction threshold value may be set to 0.7. This may indicate that a qualifying behavior with a probability score above 0.7 belongs to the distracting category of data. The distraction threshold value may be configured for each segmented region of background data and/or for each detected qualifying behavior. In other words, the distraction threshold value may be set to a different value for each detected qualifying behavior. For example, when the qualifying behavior is a motion in the background data, it may be determined that a probability score above 0.7 indicates the motion is distracting (e.g., belongs to the distracting category of data). In this example, the distraction threshold value may be set to 0.7. In another example, when the qualifying behavior is an object such as a TV in the background data, it may be determined that a probability score above 0.8 indicates the TV is distracting. In this example, the distraction threshold value may be set to 0.8.

When the qualifying behavior is classified as belonging to a distracting category of data (e.g., when it is classified as a distracting behavior), the classification component 220 and/or the thresholding component 230 may be configured to apply an effect to the region of the background data that includes the qualifying behavior to reduce an appearance of the qualifying behavior. In this regard, an effect may be applied to the region of the background data that includes the qualifying behavior to reduce an appearance of the qualifying behavior when the probability score is above the distraction threshold value. In some examples, an effect may be applied to the background data to reduce an appearance of one or more regions of the background data that include the at least one qualifying behavior. In one example, when the affect is applied to the region of the background data that includes the qualifying behavior, the effect may include blurring the region of the background data that includes the qualifying behavior. In another example, when the effect is applied to the background data, the effect may include blurring the background data to reduce an appearance of the qualifying behavior. In one example, the background data may be blurred to reduce an appearance of the distracting motion. As such, an effect, such as blurring, may be applied to the background data to reduce an appearance of at least one qualifying behavior and an effect, such as blurring, may be applied to one or more regions of the background data to reduce an appearance of the at least one qualifying behavior. It is appreciated that any effect may be applied in accordance with the present disclosure that can reduce an appearance of a qualifying behavior.

In one example, when a qualifying behavior is detected in one or more regions of the background data, a bounding box may be applied to the one or more regions including the at least on qualifying behavior. In this regard, an additional effect may be applied to the bounding box to further reduce the appearance of the one or more regions of the background data that include the at least one qualifying behavior. As such, a first effect may be applied to the background data and a second effect may be applied to one or more regions of the background data. In some examples, the bounding box facilitates the application of the effect to a finer region of the qualifying behavior.

In one example, a distraction profile may be created for each region of the background data defined by the segmentation component 210. In another example, a distraction profile may be created for each qualifying behavior detected via the classification component 220. For example, a distraction profile may be created for a first type of motion (e.g., a pet moving in the background). In another example, a distraction profile may be created for a second type of motion (e.g., a person moving around in the background). In yet another example, a distraction profile may be created for an object in the background such as a TV. In this regard, when each of these qualifying behaviors is detected in the background data, the classification component 220 may apply one or more classification models associated with each qualifying behavior. The one or more classification models may have a distraction profile associated with each qualifying behavior.

In aspects, as discussed above, the integrated system 200 may include the gesture detection model 240. The gesture detection model 240 may be configured to detect and correct inappropriate and/or unintended content and/or gestures. The content and/or data may be produced in an online video feed during a video communication. For example, the video communication may include a video call, conference, meeting, and the like using a video application and/or video platform. In one example, the video application and/or video platform may include video platforms such as Teams, Zoom, Slack, and the like. It is appreciated that any video communication technology, application, and/or platform may be used to produce content and/or data for use in conjunction with the present disclosure. The gesture detection model 240 may include any combination of machine learning based techniques and rules. In some cases, the machine learning based techniques may include techniques such as artificial neural networks, convolutional neutral networks, Bayesian classifiers, and/or genetically derived algorithms and/or functions.

In another example, the gesture detection model 240 may be trained using training data. For example, a plurality of samples of data including defined inappropriate and/or unintended gestures may be used to train the gesture detection model 240 to detect and correct inappropriate content. The defined inappropriate and/or unintended gestures may include gestures such as yawning, coughing, nose picking, and the like. As discussed above, the gesture detection model 240 may include the deep learning component 245. The deep learning component 245 may be configured to detect an unintentional gesture in the foreground data. For example, the deep learning component 245 may apply one or more (e.g., a combination) of machine learning based techniques/deep learning models to the one or more successive frames of the foreground data to detect an unintentional gesture. In some examples, the deep learning component 245 may determine that the foreground data includes a match to one of the defined inappropriate gestures that have been characterized by the deep learning component 245. In response to detecting the unintentional gesture in the foreground data, the deep learning component 245 may automatically turn off the video feed. In this regard, other participants in a video communication will not be exposed to the inappropriate gesture. Thus, avoiding disruption of the video communication.

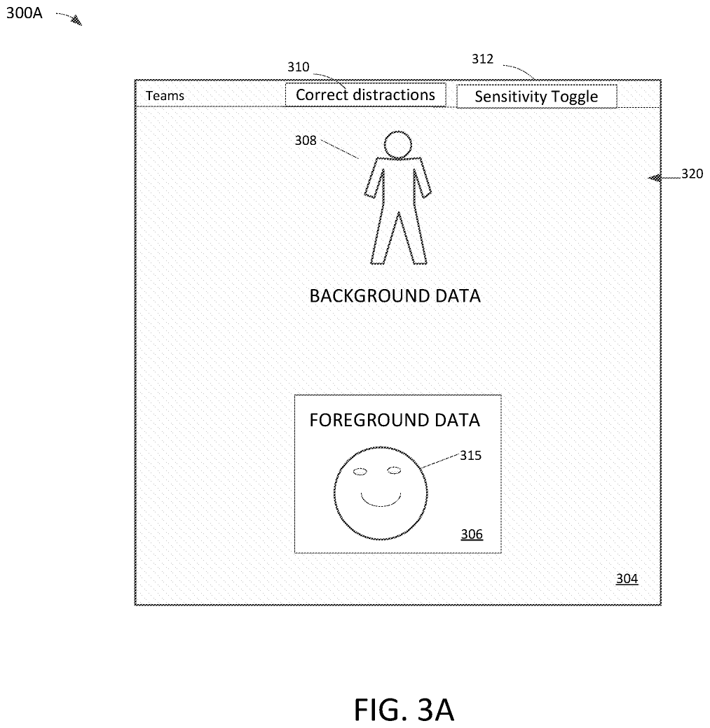

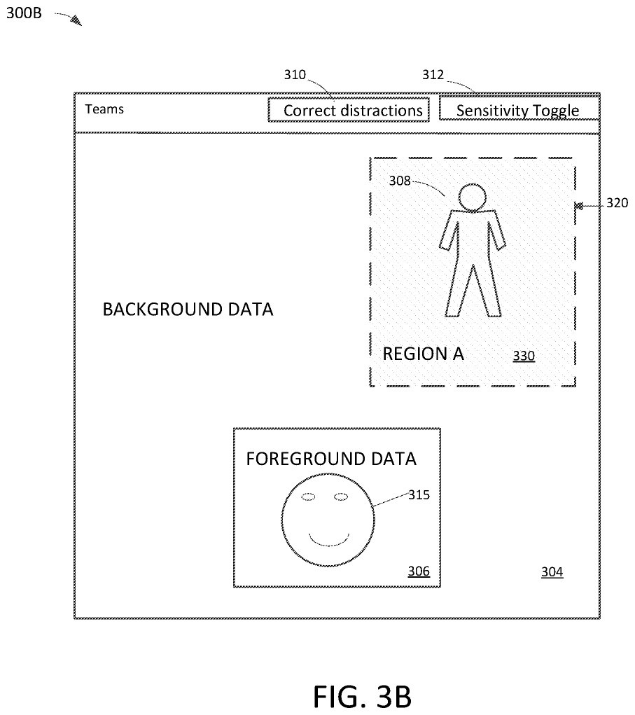

Referring now to FIG. 3A, one view 300A in a progression of views of a video communication application displayed on a user interface of the client computing device 104, such as a desktop computer, tablet computer or a mobile phone, for example, is shown. As illustrated, the exemplary view 300A of the video communication application displayed on the client computing device 104 includes background data 304, foreground data 306, a qualifying behavior 308, a correct distractions feature 310, a sensitivity toggle feature 312, a participant 315 and an applied effect 320. The video communication application illustrated in FIG. 3A is Teams. In this regard, the participant 315 may be participating in a video call using the application/platform Teams. As illustrated in FIG. 3A, the participant 315 has their video feed turned on.

As discussed above, the video feed may be segmented to distinguish background data from foreground data. As such, in the illustration shown in FIG. 3A, the background data 304 has been segmented and distinguished from the foreground data 306. As shown, the foreground data 306 may include the participant 315 (e.g., their face) and the background data 304 may include the qualifying behavior 308 and the applied effect 320. In this illustration, the qualifying behavior 308 is a detected motion of a person. As such, when the integrated system (100/200), as discussed herein, determines that the qualifying behavior 308 is distracting, an effect may be applied to the background data 304 to reduce an appearance of the qualifying behavior 308 (e.g., in this case, to reduce an appearance of the detected motion of a person). As such, FIG. 3A illustrates a reduced appearance of the qualifying behavior 308 with the applied effect 320. As discussed herein, the applied effect 320 may include blurring the background data 304.

As shown in FIG. 3A, the video communication application further includes a correct distractions feature 310 and a sensitivity toggle feature 312. The correct distractions feature 310 may include a button within the video communication application that activates the enhanced content detection and correction technology as discussed herein. For example, a participant may activate the correct distractions feature 310 via an input such as selecting, clicking, etc. the correct distractions feature 310. In another example, a participant may deactivate the correct distractions feature 310 via an input such as selecting, clicking, etc. the correct distractions feature 310. As such, the participants of a video call/meeting may opt in and out of the enhanced content detection and correction technology as discussed herein using the correct distractions feature 310.

The sensitivity toggle feature 312 may include a button to activate a selection menu that includes strength options for correcting distracting content and/or inappropriate gestures. For example, the strength options in the selection menu may include low, medium, and high, for example. When a high strength option is selected, an effect may be applied to reduce the appearance of a qualifying behavior when the probability of the qualifying behavior falls in bigger range (e.g., from a lower probability up to a higher probability). When a low strength option is selected, an effect may be applied to reduce the appearance of a qualifying behavior when the probability of the qualifying behavior falls in a smaller range such as only a high probability that the qualifying behavior is distracting. In other examples, the strength options may include a list of probability scores. For example, the list of probability scores may range from 0 to 1. When a participant selects a probability score, an effect may be applied to reduce an appearance of the qualifying behavior when the determined probability score during a live video communication is above the selected probability score from the menu.

Referring now to FIG. 3B, another view 300B in a progression of views of a video communication application displayed on a user interface of the client computing device 104, such as a desktop computer, tablet computer or a mobile phone, for example, is shown. As illustrated, the exemplary view 300B of the video communication application displayed on the client computing device 104 includes the background data 304, the foreground data 306, the qualifying behavior 308, the correct distractions feature 310, the sensitivity toggle feature 312, the participant 315, the applied effect 320, and a region A 330. The video communication application illustrated in FIG. 3B is Teams. In this regard, the participant 315 may be participating in a video call using the application/platform Teams. As illustrated in FIG. 3B, the participant 315 has their video feed turned on.

As discussed above, the video feed may be segmented to distinguish background data from foreground data. As such, in the illustration shown in FIG. 3B, the background data 304 has been segmented and distinguished from the foreground data 306. As shown, the foreground data 306 may include the participant 315 (e.g., their face) and the background data 304 may include the region A 330. In this example, the region A 330 includes the qualifying behavior 308 and the applied effect 320. In this illustration, the qualifying behavior 308 is a detected motion of a person. As such, when the integrated system (100/200), as discussed herein, determines that the qualifying behavior 308 is distracting, an effect may be applied to the region A 330 of the background data 304 to reduce an appearance of the qualifying behavior 308 (e.g., in this case, to reduce an appearance of the detected motion of a person). As such, FIG. 3B illustrates a reduced appearance of the qualifying behavior 308 with the applied effect 320. As discussed herein, the applied effect 320 may include blurring the region A 330 of the background data 304.

As shown in FIG. 3B, the video communication application further includes a correct distractions feature 310 and a sensitivity toggle feature 312. The correct distractions feature 310 may include a button within the video communication application that activates the enhanced content detection and correction technology as discussed herein. For example, a participant may activate the correct distractions feature 310 via an input such as selecting, clicking, etc. the correct distractions feature 310. In another example, a participant may deactivate the correct distractions feature 310 via an input such as selecting, clicking, etc. the correct distractions feature 310. As such, the participants of a video call/meeting may opt in and out of the enhanced content detection and correction technology as discussed herein using the correct distractions feature 310.

The sensitivity toggle feature 312 may include a button to activate a selection menu that includes strength options for correcting distracting content and/or inappropriate gestures. For example, the strength options in the selection menu may include low, medium, and high, for example. When a high strength option is selected, an effect may be applied to reduce the appearance of a qualifying behavior when the probability of the qualifying behavior falls in bigger range (e.g., from a lower probability up to a higher probability). When a low strength option is selected, an effect may be applied to reduce the appearance of a qualifying behavior when the probability of the qualifying behavior falls in a smaller range such as only a high probability that the qualifying behavior is distracting. In other examples, the strength options may include a list of probability scores. For example, the list of probability scores may range from 0 to 1. When a participant selects a probability score, an effect may be applied to reduce an appearance of the qualifying behavior when the determined probability score during a live video communication is above the selected probability score from the menu.

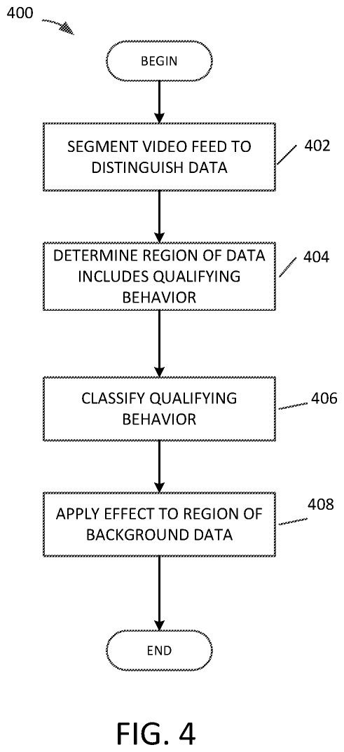

Referring now to FIG. 4, an exemplary method 400 for correcting distracting content, according to an example aspect is shown. Method 400 may be implemented on a computing device or a similar electronic device capable of executing instructions through at least one processor. Method 400 may begin at operation 402, where a video feed is segmented to distinguish background data from foreground data. In one example, one or more successive frames of data may be received at a segmentation component. In one example, the one or more successive frames of data received at the segmentation component may include four successive frames of data. In another example, the one or more successive frames of data received at the segmentation component may include eight successive frames of data. The background data may be distinguished from the foreground data by applying one or more (e.g., a combination) of segmentation models to the video feed. In one example, the foreground data may include a face and/or body of a person participating in the videoconferencing call/meeting. The background data may include the area behind and surrounding the person participating in the videoconferencing call, i.e., the background of the video feed. In this regard, the background data may include one or more regions including objects, sounds, people, pets, nature, and the like.

When a video feed is segmented to distinguish background data from foreground data, flow proceeds to decision operation 404 where it is determined that a region of the background data includes a qualifying behavior. The qualifying behavior may include any behavior that can be classified as distracting, cause disruption to a meeting (e.g., during a video communication), and/or cause participants to feel uncomfortable. For example, the qualifying behavior may include at least one of a motion and an object. The motion may include any type of motion detected in the background data, as discussed herein. For example, the motion may include a person, a pet, a plant, nature, or any object that is in motion. The object may include any object in the background data such as a plant, a TV, furniture, a picture, a pet, and the like. Determining that a region of the background data includes a qualifying behavior may include applying a classification model such as traditional computer visioning techniques, a motion detection model, and deep learning models. For example, the motion detection model may process and analyze successive frames of background data to detect a difference in pixels from one frame to the next. This may indicate that at least a region of the background data includes a qualifying behavior.

When it is determined that a region of the background data includes a qualifying behavior, flow proceeds to operation 406 where the qualifying behavior is classified as belonging to a distracting category of data. In one example, a classification component may include one or more classification models that include at least one of traditional computer visioning techniques and deep learning models. The distracting category of data may include qualifying behaviors that are characterized as distracting. For example, the classification component may classify motion as a distracting motion. In this example, the classification component may detect a motion in a region of the background data and classify it as a distracting motion. In one example, classifying the qualifying behavior as belonging to a distracting category of data includes applying a classification model to the background data to obtain a probability score. The probability score may be associated with the qualifying behavior. For example, the probability score may indicate the probability of the qualifying behavior belonging to the distracting category of data. For example, when the qualifying behavior is a motion detected in the background data, the probability score of the motion indicates the probability that the motion is a distracting motion.

When the qualifying behavior is classified as belonging to a distracting category of data, flow proceeds to operation 408 where an effect is applied to the region of the background data that includes the qualifying behavior to reduce an appearance of the qualifying behavior. In one example, the effect applied to the region of the background data that includes the qualifying behavior may include a blurring effect. In some examples, a bounding box may be applied to the region including the qualifying behavior. In this regard, an additional effect may be applied to the bounding box to further reduce the appearance of the region of the background data that includes the qualifying behavior. In some examples, the bounding box facilitates the application of the effect to a finer region of the qualifying behavior. As such, a video communication may proceed without disruption or distraction.

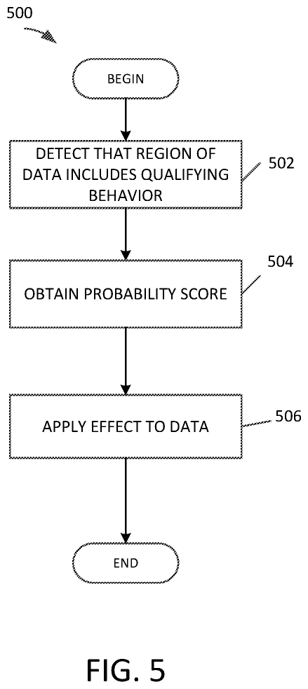

Referring now to FIG. 5, an exemplary method 500 for classifying a distracting category of data for correction, according to an example aspect is shown. Method 500 may be implemented on a computing device or a similar electronic device capable of executing instructions through at least one processor. Method 500 begins at operation 502 where one or more regions of background data including at least one qualifying behavior are detected. For example, a classification component may detect that two regions of the background data include at least one qualifying behavior. For example, one region may include a motion and the other region may include an object such as a TV. As discussed above, the segmentation component may be configured to distinguish background data from foreground data and distinguish one or more regions of the background data. In this regard, when the background data is segmented into multiple regions, the classification component may be configured to determine whether each region of the multiple regions of background data includes a qualifying behavior

When one or more regions of background data including at least one qualifying behavior are detected, flow proceeds to operation 504 where a probability score associated with the at least one qualifying behavior is obtained. Obtaining a probability score may include supplying the background data to a classification component (e.g., supplying the background data to one or more classification models). When the background data is supplied to the classification component, the classification component may compare the background data including at least one qualifying behavior to a distraction profile. The distraction profile may include distraction characteristics that indicate the qualifying behavior belongs to the distracting category of data. For example, the distraction profile may indicate that XYZ characteristics of a qualifying behavior are distracting and belong to the distracting category of data. In this regard, when the detected qualifying behavior is compared to the distraction profile, a match percentage between the characteristics of the detected qualifying behavior and the distraction characteristics included in the distraction profile may be determined. For example, the characteristics of the detected qualifying behavior may match 70% of the distraction characteristics included in the distraction profile. In this example, the probability score may be 0.7.

When a probability score associated with the at least one qualifying behavior is obtained, flow proceeds to decision operation 506 where an effect is applied to the background data to reduce an appearance of the one or more regions of the background data that include the at least one qualifying behavior. In one example, the effect is applied to the background data to reduce an appearance of the one or more regions of the background data that include the at least one qualifying behavior when the probability score is above a distraction threshold value. In one example, the effect that is applied to the background data to reduce an appearance of the one or more regions of the background data that include the at least one qualifying behavior is blurring. In this regard, applying the effect to the background data may include blurring the background data to reduce the appearance of the at least one qualifying behavior.

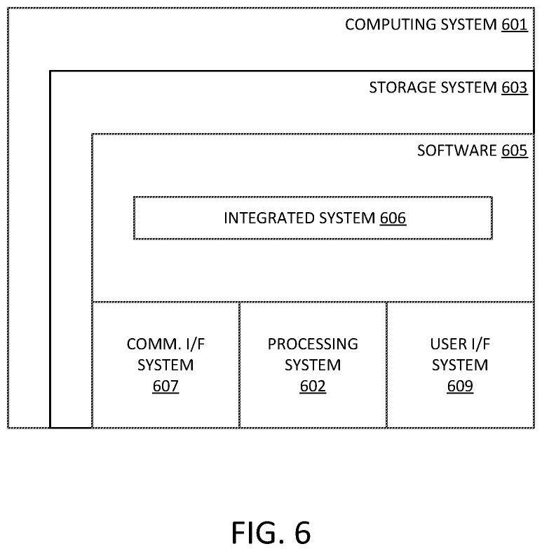

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes integrated system 606, which is representative of the platforms, applications and enhanced content detection and correction technology discussed with respect to the preceding FIGS. 1-5. When executed by processing system 602 to enhance content detection and correction, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced content detection and correction systems.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include integrated system 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced content detection and correction systems. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: at least one processor; and memory encoding computer executable instructions that, when executed by the at least one processor, perform a method for correcting distracting content, the method comprising: segmenting a video feed to distinguish background data from foreground data; determining that a region of the background data includes a qualifying behavior; classifying the qualifying behavior as belonging to a distracting category of data; and applying an effect to the region of the background data that includes the qualifying behavior to reduce an appearance of the qualifying behavior. In further examples, segmenting the data to distinguish the background data from the foreground data comprises receiving one or more successive frames of the data at a segmentation component. In further examples, the segmentation component includes one or more segmentation models for distinguishing one or more regions of the background data. In further examples, classifying the qualifying behavior as belonging to a distracting category of data comprises applying a classification model to the background data to obtain a probability score. In further examples, applying an effect to the region of the background data that includes the qualifying behavior to reduce an appearance of the qualifying behavior comprises blurring the region of the background data that includes the qualifying behavior. In further examples, the qualifying behavior includes at least one of a motion and an object. In further examples, the method further comprises: detecting an unintentional gesture in the foreground data; and in response to detecting the unintentional gesture in the foreground data, automatically turning off the video feed. In further examples, detecting an unintentional gesture in the foreground data comprises applying a deep learning component to one or more successive frames of the video feed.

Further aspects disclosed herein provide an exemplary method for classifying a distracting category of data for correction, the method comprising: detecting that one or more regions of background data include at least one qualifying behavior; obtaining a probability score associated with the at least one qualifying behavior; and when the probability score is above a distraction threshold value, applying an effect to the background data to reduce an appearance of the one or more regions of the background data that include the at least one qualifying behavior. In further examples, obtaining a probability score associated with the at least one qualifying behavior comprises: supplying the background data to a classification component, wherein the classification component includes at least a distraction profile; and comparing the background data including the at least one qualifying behavior to the distraction profile. In further examples, the distraction profile includes distraction characteristics that indicate the qualifying behavior belongs to a distracting category of data. In further examples, the computer-implemented method further comprises applying a bounding box to the one or more regions including the at least one qualifying behavior. In further examples, the computer-implemented method further comprises applying an additional effect to the bounding box to further reduce the appearance of the one or more regions of the background data that include the at least one qualifying behavior. In further examples, applying an effect to the background data to reduce an appearance of the one or more regions of the background data that include the at least one qualifying behavior comprises blurring the background data. In further examples, the classification component includes one or more classification models that include at least one of traditional computer visioning techniques and deep learning models. In further examples, the computer-implemented method further comprises segregating a video feed to identify the background data. In further examples, the qualifying behavior includes at least one of a motion and an object.

Additional aspects disclosed herein provide exemplary systems comprising: one or more computer readable storage media; and program instructions stored on the one or more computer readable storage media that, when executed by at least one processor, cause the at least one processor to at least: segment data to distinguish background data from foreground data; detect a motion in a region of the background data; classify the motion as a distracting motion; and apply an effect to the background data to reduce an appearance of the distracting motion. In further examples, to classify the motion as a distracting motion, the program instructions, when executed by at least one processor, cause the at least one processor to at least supply the background data to a classification component to obtain a probability score. In further examples, the classification component includes at least a combination of machine learning based techniques and rules.

Techniques for detecting and correcting undesirable content are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of enhanced content detection and correction systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
at least one processor; and
memory encoding computer executable instructions that, when executed by the at least one processor, perform a method for correcting distracting content, the method comprising:
segmenting a video feed to distinguish background data from foreground data;
determining that a region of the background data includes a qualifying behavior;
classifying the qualifying behavior as belonging to a distracting category of data; and
applying an effect to the region of the background data that includes the qualifying behavior to reduce an appearance of the qualifying behavior.

2. The system of claim 1, wherein segmenting the data to distinguish the background data from the foreground data comprises receiving one or more successive frames of the data at a segmentation component.

3. The system of claim 1, wherein the segmentation component includes one or more segmentation models for distinguishing one or more regions of the background data.

4. The system of claim 1, wherein classifying the qualifying behavior as belonging to a distracting category of data comprises applying a classification model to the background data to obtain a probability score.

5. The system of claim 1, wherein applying an effect to the region of the background data that includes the qualifying behavior to reduce an appearance of the qualifying behavior comprises blurring the region of the background data that includes the qualifying behavior.

6. The system of claim 1, wherein the qualifying behavior includes at least one of a motion and an object.

7. The system of claim 1, the method further comprising:
detecting an unintentional gesture in the foreground data; and
in response to detecting the unintentional gesture in the foreground data, automatically turning off the video feed.

8. The system of claim 7, wherein detecting an unintentional gesture in the foreground data comprises applying a deep learning component to one or more successive frames of the video feed.

9. A computer-implemented method for classifying a distracting category of data for correction, the method comprising:
detecting that one or more regions of background data include at least one qualifying behavior;
obtaining a probability score associated with the at least one qualifying behavior; and
when the probability score is above a distraction threshold value, applying an effect to the background data to reduce an appearance of the one or more regions of the background data that include the at least one qualifying behavior.

10. The computer-implemented method of claim 9, wherein obtaining a probability score associated with the at least one qualifying behavior comprises:
supplying the background data to a classification component, wherein the classification component includes at least a distraction profile; and
comparing the background data including the at least one qualifying behavior to the distraction profile.

11. The computer-implemented method of claim 10, wherein the distraction profile includes distraction characteristics that indicate the qualifying behavior belongs to a distracting category of data.

12. The computer-implemented method of claim 9, further comprising applying a bounding box to the one or more regions including the at least one qualifying behavior.

13. The computer-implemented method of claim 12, further comprising applying an additional effect to the bounding box to further reduce the appearance of the one or more regions of the background data that include the at least one qualifying behavior.

14. The computer-implemented method of claim 9, wherein applying an effect to the background data to reduce an appearance of the one or more regions of the background data that include the at least one qualifying behavior comprises blurring the background data.

15. The computer-implemented method of claim 10, wherein the classification component includes one or more classification models that include at least one of traditional computer visioning techniques and deep learning models.

16. The computer-implemented method of claim 9, further comprising segregating a video feed to identify the background data.

17. The computer-implemented method of claim 9, wherein the qualifying behavior includes at least one of a motion and an object.

18. A system comprising:
one or more computer readable storage media; and
program instructions stored on the one or more computer readable storage media that, when executed by at least one processor, cause the at least one processor to at least:
segment data to distinguish background data from foreground data;
detect a motion in a region of the background data;
classify the motion as a distracting motion; and
apply an effect to the background data to reduce an appearance of the distracting motion.

19. The system of claim 18, wherein to classify the motion as a distracting motion, the program instructions, when executed by at least one processor, cause the at least one processor to at least supply the background data to a classification component to obtain a probability score.

20. The system of claim 19, wherein the classification component includes at least a combination of machine learning based techniques and rules.
